(19) United States
(12) Patent Application Publication
(10) Pub. No.: US 2002/0172367 A1
(43) Pub. Date: Nov. 21, 2002

(54) System for secure electronic information transmission

(75) Inventors: David G. Mulder, Toronto (CA); Robert Miskimmin, Toronto (CA); Trevor Bain, Toronto (CA); Kathirkamanathan Nadarajah, North York (CA); David Brown, Mississauga (CA)

Correspondence Address: Joseph R. Keating, Esq., Keating & Bennett LLP, Suite 312, 10400 Eaton Place, Fairfax, VA, 22030, US

(73) Assignee: KASTEN CHASE APPLIED RESEARCH LIMITED, Mississauga (CA)

(21) Appl. No.: 10/147,125

(22) Filed: May 16, 2002

Related U.S. Application Data
(60) Provisional application No. 60/291,460, filed on May 16, 2001.

(51) Int. Cl. H04L 9/00

(52) U.S. Cl. 380/277; 713/200

(57) ABSTRACT

A method for secure electronic information exchange between a sender and a recipient. The method includes generating a message at a first entity, generating a message encryption key, encrypting the message using the message encryption key, wrapping the message encryption key using a key agreement algorithm, generating a Java archive file including the encrypted message, the wrapped message encryption key and cryptographic algorithm code including decryption algorithm and key agreement algorithm code, encoding the Java archive file, embedding the encoded Java archive file in an HTML file, and sending the HTML file as an e-mail attachment to said recipient.

### FIELD OF THE INVENTION

The present invention relates in general to electronic information transmission and more particularly to a method and apparatus for information transfer from one entity to another entity via electronic transmission medium, such as e-mail, in a secure manner.

### BACKGROUND OF THE INVENTION

Since its advent in the mid-twentieth century, the Internet (originally Arpanet) has provided an electronic information exchange alternative to posted mail, courier and, latterly, facsimile mail. The Internet was initially developed by the military as a distributed communication network designed to operate in the event one or more of the network nodes is rendered unserviceable by military attack. Since about 1990, the consistent efforts of software developers such as Microsoft, Netscape, etc. to provide user-friendly applications have facilitated penetration of the Internet into commercial and residential markets.

One area of intense research and development in the field of electronic information exchange is security of document transmission. The prior art is replete with examples of key based encryption/decryption systems, digital signature authentication systems, etc. Although by no means exhaustive, the following U.S. patents are exemplary of the prior art: U.S. Pat. No. 6,014,688, U.S. Pat. Nos. 5,958,005; 6,002,769, U.S. Pat. No. 6,185,603, U.S. Pat. No. 5,573,316, U.S. Pat. No. 5,870,544, U.S. Pat. No. 6,223,287, U.S. Pat. No. 6,212,535, U.S. Pat. No. 6,091,835, U.S. Pat. No. 6,023,764 and U.S. Pat. No. 5,890,129. All of the foregoing prior art systems rely on one or more of client software plug-ins, key services or “shared secrets” to implement message encryption, thereby rendering the systems proprietary (i.e. not generic), complex and expensive, and cumbersome to use. These disadvantages particularly mitigate against the successful implementation of such prior art systems in large-scale e-commerce applications such as electronic billing and presentment systems for public utilities or telephone companies or electronic statement delivery systems for banks and brokerages etc.

It is an object of an aspect of the present invention to provide a secure electronic information transmission system that obviates or mitigates at least some of the above-stated shortcomings of the prior art and which is susceptible of implementation in large-scale e-commerce applications and e-document delivery systems.

### SUMMARY OF THE INVENTION

According to an aspect of the present invention, a method and apparatus are provided for secure electronic information exchange between entities wherein in one of the embodiments, cryptographic algorithm code, including decryption algorithm and key agreement algorithm or key exchange algorithm code, wrapped encryption or session key, sender's public key and some information such as the sender identification, recipient identification, encrypted information content and a viewer applet are all transmitted to the recipient. In an aspect of the preferred embodiment the above items are sent to the recipient in a signed Java Archive file (JAR), that is encoded and embedded into an HTML file. The recipient system (i) verifies the authenticity and integrity of the JAR file using the digital signature algorithm and root certificate of standard Internet browsers. The Java Archive file is then opened and applets are loaded which in turn instruct the recipient to enter a password, whereupon the (ii) recipient is authenticated by unwrapping and utilizing the recipient's private key, (iii) the key agreement algorithm or key exchange algorithm, is used along with the recipient's private key and, in the case of the key agreement algorithm, the sender's public key, to unwrap the message encryption key, (iv) the decryption algorithm is used along with the message encryption key to decrypt the encrypted information content, and (v) the information content is displayed to the recipient using the viewer applet. Preferably, Internet e-mail is used as the transport methodology for the embedded and encoded JAR although operation of the invention is not reliant upon the specific transport methodology.

One of the advantages of the present invention over the known prior art is the reduced involvement and effort of the recipient in order to receive and view the secure information. Thus, the system of the present invention may be advantageously implemented for sending secure e-mail from one large entity to many smaller entities. The information thus sent is encrypted using advanced encryption algorithms that guarantee privacy within the limits of existing technology. The generation and upkeep of the key pairs is the responsibility of the large entity (sender). The small entity (recipient) is able to view the encrypted message using a browser plug-in and a viewer applet launched from a standard web browser (e.g. an Internet browser such Netscape or Explorer). The recipient simply receives or enters and then guards the recipient's private key for viewing the first and subsequent secured messages. There is platform and operating system independence for the recipient, in contrast with the known prior art.

In one aspect of an embodiment of the present invention, there is provided a method for secure electronic information delivery from a sender to a recipient. The method includes generating a message at a first entity, generating a message encryption key, encrypting the message using the message encryption key, wrapping the message encryption key using a key agreement algorithm, generating a Java archive file including the encrypted message, the wrapped message encryption key and cryptographic algorithm code including decryption algorithm and key agreement algorithm code, encoding the Java archive file, embedding the encoded Java archive file in an HTML file, and sending the HTML file as an e-mail attachment to said recipient.

In another aspect of the invention, there is provided an apparatus for secure electronic information delivery from a sender to a recipient. The apparatus comprises a secure delivery service in communication with a message generating utility for receiving a message therefrom. The secure delivery service includes a message encryption key generator, an encryption module for encrypting the message using the message encryption key and for wrapping the message encryption key using a key agreement algorithm, a Java archive file generator for generating a Java archive file including the encrypted message, the wrapped message encryption key and cryptographic algorithm code including decryption algorithm and key agreement algorithm code and an encoder for encoding the Java archive file. The secure delivery service is operable to embed the encoded Java archive file in an HTML file and send the HTML file as an e-mail attachment to the recipient.

### BRIEF DESCRIPTION OF THE DRAWINGS

The invention will be better understood with reference to the drawings and the following description in which:

FIG. 1 is a block diagram of a registration system, in accordance with an aspect of an embodiment of the present invention;

FIG. 2 is a flow chart showing the process steps for registration with a registration authority, in accordance with an aspect of the embodiment of FIG. 1;

FIG. 3 is a flow chart showing process steps for information transfer from a sender to a recipient via e-mail or electronic transmission medium according to a preferred embodiment of the present invention;

FIG. 4 is a block diagram of an apparatus for information transfer from a sender to a recipient via e-mail or electronic transmission medium according to the embodiment of FIG. 3; and

FIG. 5 is a block diagram of an apparatus for information transfer from a sender to a recipient via e-mail or electronic transmission medium according to an alternative embodiment of the present invention.

### DETAILED DESCRIPTION OF THE PREFERRED EMBODIMENTS

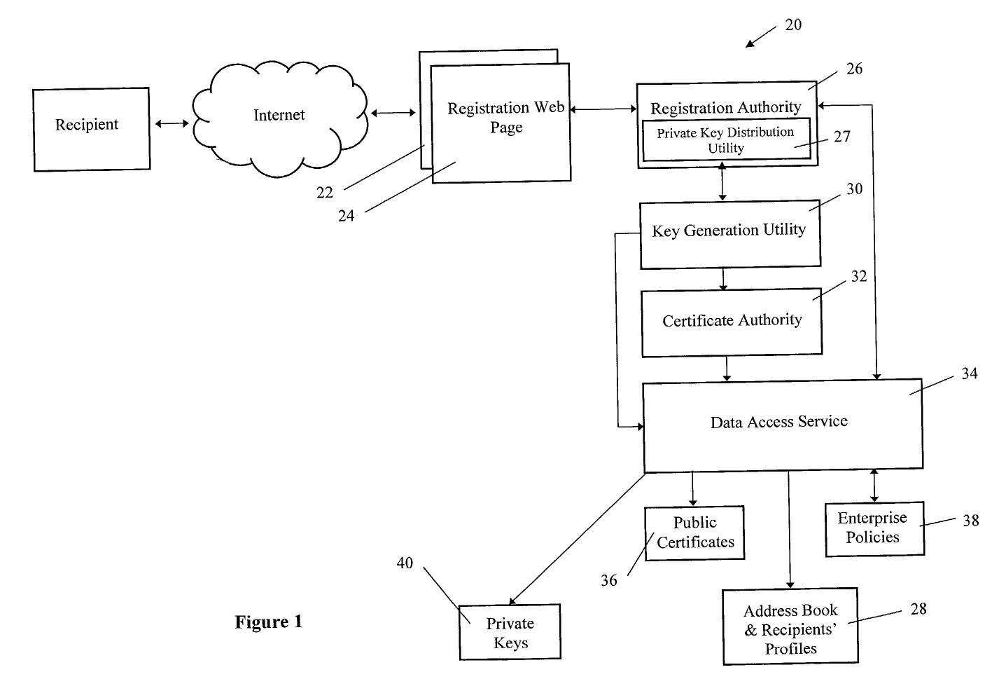

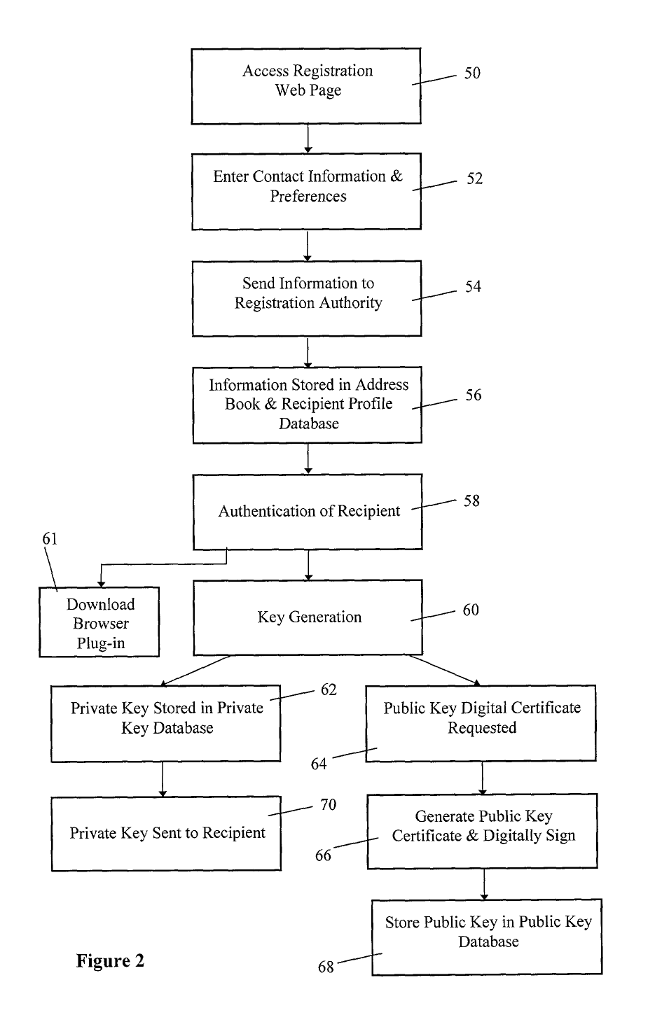

FIG. 1 is a block diagram of a registration system, in accordance with an aspect of an embodiment of the present invention. FIG. 2 is a flow chart showing the process steps for registration with a registration authority, in accordance with an aspect of the embodiment of FIG. 1.

Reference is first made to FIGS. 1 and 2 to describe the registration system indicated generally by the numeral 20. The registration system 20 includes a web service (not shown) that supports a local web site 22 and a registration web page 24 at the web site 22. The registration authority 26 is a processing application that provides an interface for the registration of a new recipient through the registration web page 24. The registration authority 26 provides the utilities for collection of a recipient's contact information and personal preferences which are stored in an address book and recipients' profile database 28. The registration authority 26 also provides a key distribution utility 27 for delivery of a private key to a recipient as well as utilities for the recipient to modify personal records and to re-deliver the recipient's private key or deliver a new private key to a recipient, when desired.

The registration system 20 also includes a key generation utility 30 for generating public and private encryption keys in the registration system. A certificate authority 32 receives the public key, generates a public-key certificate and signs the public key certificate, binding the recipient's identification to the public key.

The private encryption key is sent to the recipient via the private key distribution utility 27, which provides secure, transparent download and storage of the recipient's private key through the registration web pages 24 over a secure connection. In another embodiment, the private encryption key is sent to the recipient via “out of band” methods such as CD ROM or impact-printed statements snail mailed to the recipient.

A data access service 34 provides transparent and secure access to various data sources. The data access service 34 maintains a database of the public key certificates 36, containing the public keys generated for use by the electronic document delivery system described below, when delivery of a secure e-document to a recipient is desired. An example of a suitable data access service is an X.500 directory service. The data access service 34 also maintains the address book and recipients' profile database 28 including the contact information of the recipient and the recipient preferences. These preferences include, for example, the manner in which each recipient prefers to receive electronic documents and other personal messages, such as receiving messages on a personal computer including attachments, on a personal digital assistant (PDA) without attachments or posting to a secure personal web page. This address book and recipient's profile database 28 is shared with the electronic document delivery system.

An enterprise policies database 38 is also provided for storing the data associated with the operational and security policies related to the delivery of e-documents. For example, data relating to the roles and privileges for administration and management of the system is stored.

A private key database 40 is provided for secure archival of the recipient's private encryption key, using known secure methods.

In order to receive secure e-documents, the recipient accesses the registration web page 24 (Step 50) via the Internet using the recipient's web browser. The recipient accesses the registration web page 24 via secure HTTPS connection from a web browser and is then prompted to enter information such as the recipient's contact information, e-mail address and personal preferences (Step 52). This information is sent via the HTTPS connection to the registration authority 26 (Step 54) and stored in the address book and recipient profile database 28 (Step 56). Next, the registration authority 26 carries out an authentication through the registration authority web page 24 based on for example, a shared secret such as a web log-on identification and password, a personal identification number, a pass phrase, or a certificate exchange if the browser is SSL enabled (secure sockets layer protocol) with client side authentication (Step 58). After successful authentication, a browser plug-in is downloaded to the recipient's system (step 61) for use in decoding an encoded file. The key generation utility 30 generates a public key and private key pair for the recipient (Step 60). The private key is archived in the private key database 40 (Step 62) and the public key is forwarded to the certificate authority 32 as part of a digital certificate request (Step 64). The certificate authority 32 generates a digital public key certificate, which includes the recipient's identification information and public encryption key (Step 66), digitally signs the public key certificate and stores the public key certificate in the public certificates database 36 (Step 68). The private encryption key is then sent to the recipient (Step 70). In the present embodiment, the private encryption key is sent to the recipient via the private key distribution utility 27, which provides secure, transparent download and storage of the recipient's private key through the registration web page 24 over a secure connection.

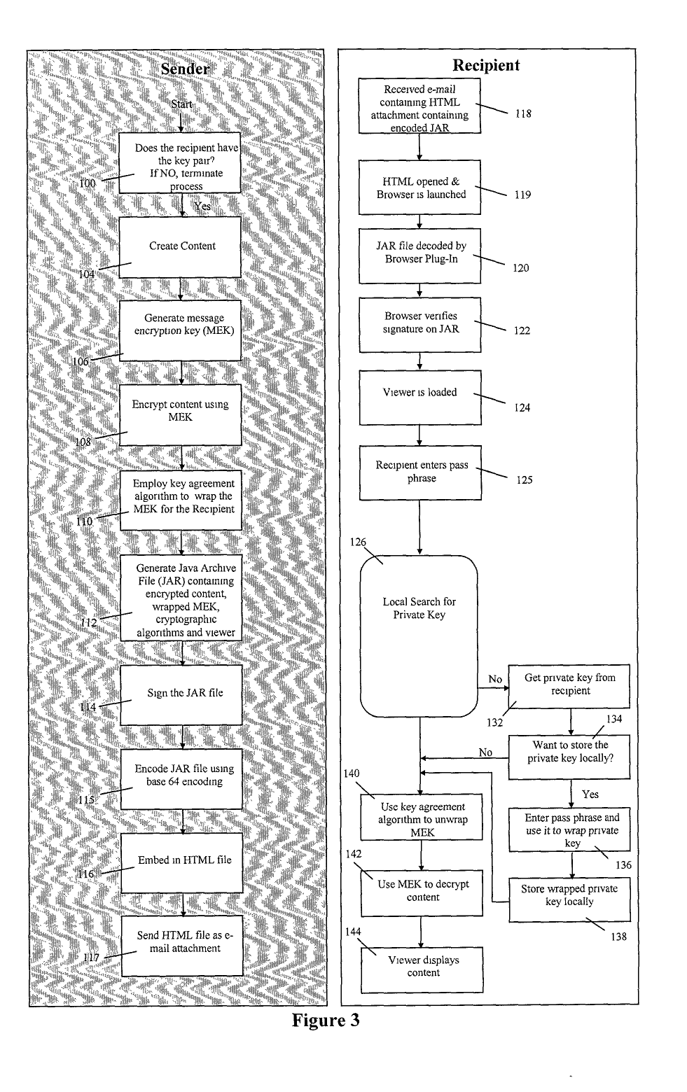

FIG. 3 is a flowchart showing process steps for secure electronic information transmission according to an aspect of an embodiment of the present invention.

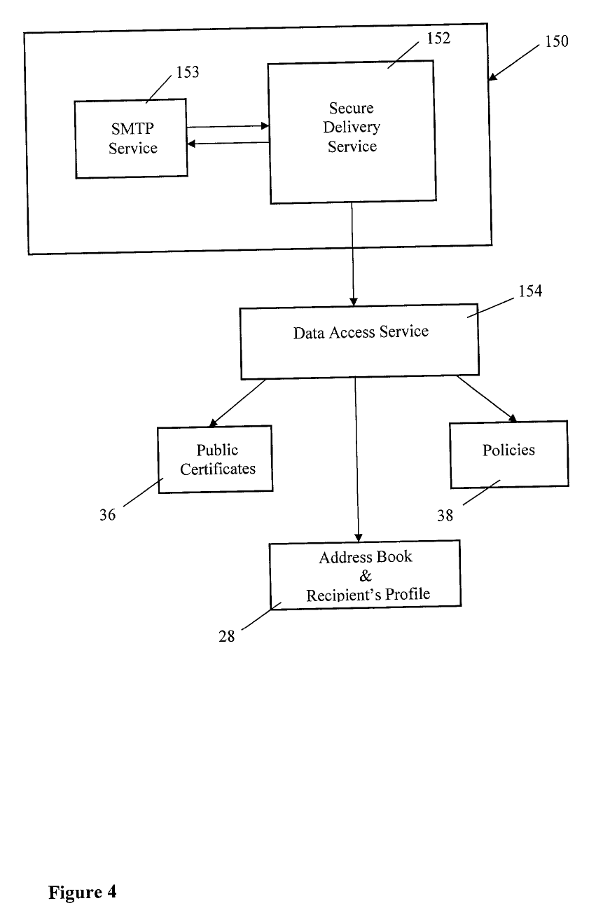

The process starts within the sender with a determination as to whether or not a key pair has already been generated (Step 100). If no key pair has been generated, the process terminates. Next, the sender creates the information content for the message to be transmitted (Step 104). The secure delivery system (FIG. 4) then employs a symmetric algorithm (such as Triple DES or AES), generating a message encryption key and encrypting the content using this key (step 108). As would be understood by those of skill in the art, a message encryption key is generated each time a new message is created for sending to a recipient. Next a key exchange or key agreement algorithm wraps the message encryption key for transfer to the recipient (Step 110). A key agreement algorithm (such as Diffie-Hellman) uses the public key generated by the key generation utility 30 and the sender's private key to create a shared secret, as would be understood by those of skill in the art, to wrap the message encryption key. A Java Archive file (JAR file) is then generated which contains the cryptographic algorithm code including the decryption algorithm and key agreement algorithm code, the wrapped message encryption key (MEK), the sender's public key, the encrypted content, the viewer and some additional information regarding the sender and the recipient (Step 112). The JAR file is signed using a digital signature algorithm and a private signing key belonging to the sender (Step 114) and encoded using for example, base 64 encoding, as would be understood by those of skill in the art (Step 115). Next, the digitally-signed and encoded file is embedded into an HTML file (Step 116). The HTML file is sent to an intended recipient, for example as an email attachment (Step 117).

Upon receipt of the e-mail containing the HTML file which contains the encoded JAR file (Step 118), the recipient opens the e-mail and then the HTML file and the default browser is launched (Step 119). When the recipient opens the HTML attachment, a temporary copy of the attachment is created in a temporary directory, such as a “Temporary Internet Files” directory in a Windows™ environment and is run from the temporary directory. Java script in the HTML file determines the platform and web browser being used. Java script in the HTML file passes the base 64 encoded JAR file to the browser plug-in which decodes the JAR file (Step 120) and sends the decoded JAR file back to the browser. In the present embodiment, the decoded JAR file is written into a temporary JAR file and the temporary JAR file is created in the same directory as the original HTML attachment.

When the browser receives the signed JAR file, it verifies the signature on the JAR file using a root certificate (Step 122), as would be well understood by those of skill in the art. The browser prompts the recipient with a Java security warning. Next, Java script in the HTML file code invokes the viewer applet in the JAR file (Step 124) and the recipient is prompted for a pass phrase. When the recipient enters the recipient's pass phrase (Step 125), a local search for the private key is carried out (Step 126). If the key is not found (Step 128), then the recipient's private key has not been previously stored and the recipient is prompted to enter the private key (Step 132). The recipient is further prompted to store the private key locally (Step 134) in response to which a pass phrase is entered for use in wrapping the private key (Step 136) and the wrapped private key is locally stored (Step 138) using, for example PKCS 12 or Java Keystore standard.

In the event that the private key is found locally (Step 126), has just been locally stored (Step 138) or has been entered directly by the recipient without local storage (Step 134), then the key agreement algorithm is used to unwrap the MEK (Step 140). The unwrapped MEK is used to decrypt the message content (Step 142), and the viewer is used to display this content to the recipient (Step 144).

The process of FIG. 3 is implemented according to the present invention by means of the secure delivery system of FIG. 4, indicated generally by the numeral 150. The secure delivery system 150 includes an SMTP service 153 which receives the information content, in the form of an e-mail message for example, from the sender. The SMTP service 153 forwards the e-mail message to a secure delivery service 152 for it to be secured prior to delivery to the recipient. The secure delivery service 152 receives the e-mail message and retrieves the recipient's contact information and profile and the recipient's public key from the respective databases 28, 36 via the data access service 154. The secure delivery service 152 encrypts the email message and any message attachments using the message encryption key. The message encryption key is wrapped and the Java archive file is generated, signed, encoded and embedded in an HTML file, as described above, by the secure delivery service 152. The HTML file is then attached to an e-mail and sent to the recipient via the SMTP service 153. The policy data is also accessible via the data access service 154 for maintaining compliance with the security and operational policies related to the delivery of e-documents and maintaining the roles and privileges for administration and management of the system 150.

Alternative embodiments and variations of the invention are possible. For example, in an alternative embodiment, the viewer applet is not sent to the recipient in the JAR file, as shown in FIG. 3 and described above. Instead the viewer is already present in the recipient system, or the recipient has already received the viewer by alternate means. Thus, the JAR file need not contain the viewer.

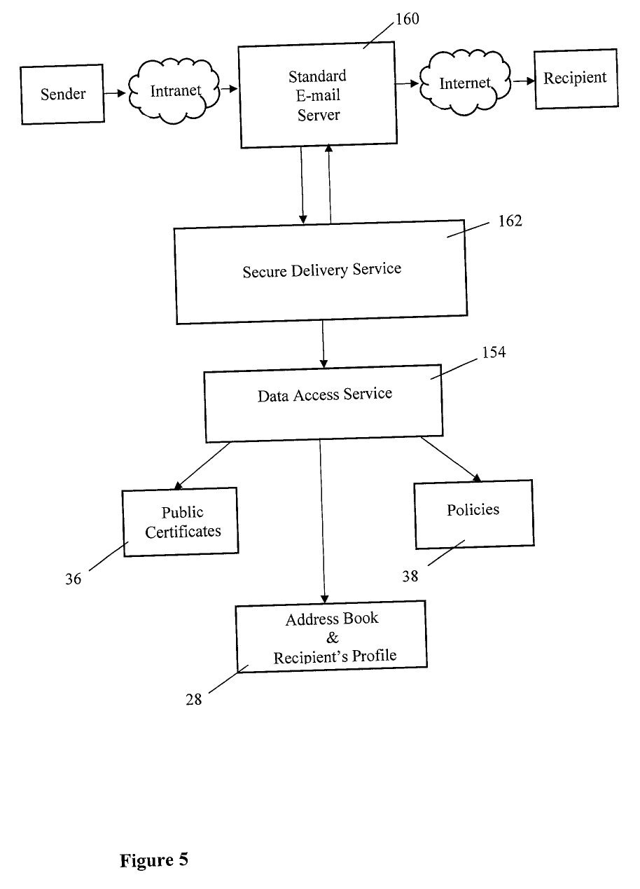

FIG. 5 shows an alternative embodiment of the secure delivery system of FIG. 4. In the embodiment shown in FIG. 5, a standard electronic mail (e-mail) server 160 exists and a secure delivery service 162 is connected to the standard e-mail server 160. Thus, the e-mail server 160 and the secure delivery service 162 are separate entities and the e-mail server 160 is not part of the secure delivery system. The standard e-mail server 160 receives a message. If the e-mail server 160 determines that the message is intended to be sent to the secure delivery service 162, the message is then transmitted to the secure delivery service 162. In the present exemplary embodiment, the e-mail includes a “spoof e-mail address”. The “spoof email address” is created at the sender, for example, automatically upon entry of the intended recipient's e-mail address or name. The “spoof e-mail address” is employed so that the standard e-mail server 160 will determine that the message is intended to be sent to the secure delivery service 162 and then direct the message to the secure delivery service 162.

The message encryption key is then generated, the content encrypted, the key agreement algorithm is employed, the JAR file created, signed, encoded and embedded in an HTML file which is sent as an e-mail attachment to the intended recipient back through the standard e-mail server 160 and through the Internet. The secure delivery service 162 is also connected to a data access service, as described in the embodiment of FIG. 4.

Other variations and modifications would occur to those of skill in the art, for example, the message can be generated by a person (e-mail client) or from an application on a machine. The cyptographic algorithms used for implementation of the invention may be selected from a group of known cryptographic algorithms such as AES, TripleDES, RSA and Elliptic Curve. The selection of the cryptographic algorithms is predicated in part by the target platform (e.g. PC, Palmtop or PDA, etc.). Still other variations and modifications exist, all of which are believed to be within the sphere and scope of the invention defined by the claims appended hereto.

1. A method for secure electronic information exchange between a sender and a recipient, comprising:
generating a message at a first entity;
generating a message encryption key;
encrypting said message using said message encryption key;
wrapping said message encryption key using a key agreement algorithm;
generating a Java archive file including the encrypted message, the wrapped message encryption key and cryptographic algorithm code including decryption algorithm and key agreement algorithm code;
encoding the Java archive file;
embedding the encoded Java archive file in an HTML file; and
sending the HTML file as an e-mail attachment to said recipient.

2. The method according to claim 1 wherein said Java archive file includes a viewer applet.

3. The method according to claim 1 wherein said Java archive file is digitally signed prior to encoding.

4. The method according to claim 1 further comprising registering the recipient including:
receiving and storing recipient information;
generating a public and private encryption key pair for said recipient; and
making available said private encryption key securely to said recipient.

5. The method according to claim 4 wherein said step of making available said private encryption key comprises sending said private encryption key to said recipient via a key distribution utility.

6. The method according to claim 4 wherein said step of registering further includes generating a public key digital certificate from said public key and storing said public key digital certificate.

7. The method according to claim 4 wherein said registering said recipient further includes sending a browser plug-in to said recipient for transparently decoding said encoded Java archive file.

8. An apparatus for secure electronic information exchange between a sender and a recipient, comprising a secure delivery service in communication with a message generating utility for receiving a message therefrom, said secure delivery service including a message encryption key generator, an encryption module for encrypting said message using said message encryption key and for wrapping said message encryption key using a key agreement algorithm, a Java archive file generator for generating a Java archive file including the encrypted message, the wrapped message encryption key and cryptographic algorithm code including decryption algorithm and key agreement algorithm code and an encoder for encoding the Java archive file wherein the secure delivery service is operable to embed the encoded Java archive file in an HTML file and send the HTML file as an e-mail attachment to said recipient.

9. The apparatus for secure electronic information exchange according to claim 8 wherein said Java archive file further includes a viewer applet.

10. The apparatus for secure electronic information exchange according to claim 8 wherein said secure delivery service further includes said e-mail service.

11. The apparatus for secure electronic information exchange according to claim 8 wherein said secure delivery service further includes a digital signature generator for digitally signing said Java archive file prior to encoding by the encoder.

12. The apparatus according to claim 8 further comprising a registration system for registering said recipient for the delivery of secure electronic information, said registration system comprising a registration authority for providing a recipient interface for collection of recipient information, and a key generation utility connected to said registration authority, said key generation utility for generating public and private encryption keys, wherein said private encryption key is made available for said recipient.

13. The apparatus according to claim 12 wherein said registration system is operable to provide a browser plug-in to the recipient.

14. The apparatus according to claim 12 wherein said registration system further comprises a certificate authority in connection with the key generation utility, for receiving the public encryption key, generating a public key certificate and binding recipient identification to the public key.

15. The apparatus according to claim 8wherein said private encryption key is made available to said recipient via a private key distribution utility.

16. The apparatus according to claim 12 wherein said registration system further comprises storage for storing said recipient information, said public key certificate and said private key.
